(19) United States
(12) Patent Application Publication
(10) Pub. No.: US 2024/0139812 A1
(43) Pub. Date: May 2, 2024

(54) METHOD FOR FABRICATING A NITROGENOUS STEEL MATERIAL

(71) Applicant: AGENCY FOR SCIENCE, TECHNOLOGY AND RESEARCH, Singapore (SG)

(72) Inventors: Baisong CHENG, Singapore (SG); Pei WANG, Singapore (SG); Cheng Cheh Dennis TAN, Singapore (SG); Kwang Boon Desmond LAU, Singapore (SG); Fengxia WEI, Singapore (SG)

(21) Appl. No.: 18/546,397

(22) PCT Filed: Mar. 28, 2022
(86) PCT No.: PCT/SG2022/050168

§ 371 Date: Aug. 14, 2023

(30) Foreign Application Priority Data
Mar. 30, 2021 (SG) 10202103247T

(51) Int. Cl. B22F 10/28; B22F 1/12; B22F 3/10; B22F 12/58; C22C 38/00; C22C 38/04; C22C 38/22; C22C 38/28

(52) U.S. Cl. CPC B22F 10/28; B22F 1/12; B22F 3/10; B22F 12/58; C22C 38/001; C22C 38/04; C22C 38/22; C22C 38/28; B33Y 10/00

(57) ABSTRACT

The present disclosure generally relates to a method for fabricating a nitrogenous steel material (200). The method comprises preparing a material powder in a powder reservoir (120) of an additive manufacturing apparatus (100). The material powder comprises: a metal powder comprising iron; and an alloying powder comprising nitrogen. The method further comprises performing an additive manufacturing process under atmospheric pressure, the additive manufacturing process comprising: displacing layers of the material powder from the powder reservoir (120) to a build platform (130) of the additive manufacturing apparatus (100); and fusing the layers of material powder on the build platform (130) to fabricate the nitrogenous steel material (200).

### CROSS REFERENCE TO RELATED APPLICATION(S)

The present disclosure claims the benefit of Singapore Patent Application No. 10202103247T filed on 30 Mar. 2021, which is incorporated in its entirety by reference herein.

### TECHNICAL FIELD

The present disclosure generally relates to nitrogenous steel materials. More particularly, the present disclosure describes various embodiments of a method for fabricating a nitrogenous steel material.

### Background

Stainless steel normally contains nickel as an alloying element to improve toughness and ductility of steel. For example, SS304 stainless steel contains about 8% to 10.5% nickel by weight and SS316 stainless steel contains about 10% to 14% nickel by weight. More than two thirds of the global nickel production is used to produce stainless steel. With increasing global demand for nickel and expected supply shortages, other elements are being considered as replacement for the nickel content in steel. Nitrogen is one example as it is more abundant and cheaper than nickel.

Steel that contains nitrogen in its composition is known as nitrogenous steel. The use of nitrogen in high alloy steel like stainless steel increases strength without restricting ductility and provides excellent corrosion resistance. Increasing the nitrogen content in steel enhances material properties like strength and corrosion resistance. Steel can be considered as high nitrogen steel if the nitrogen content is at least 0.08% by weight for ferritic steel and at least 0.4% by weight for austenitic steel. However, the solubility of nitrogen in molten steel is very low—about 0.045% by weight at 1600° C. and atmospheric pressure.

In order to increase the nitrogen content in steel beyond its atmospheric pressure solubility and produce high nitrogen steel, specialized processes such as Pressurized Induction Melting (PIM) and Pressurized Electroslag Remelting (PESR) are usually used. These processes are able to melt steels under pressures of several multiples of atmospheric pressures to increase the solubility of nitrogen and produce steels with higher nitrogen content than the limit of standard atmospheric melting processes. However, because of the high pressures required (from several tens to several hundreds of atmospheric pressures), these processes are expensive and complicated and carry safety risks.

Therefore, in order to address or alleviate at least one of the aforementioned problems and/or disadvantages, there is a need to provide an improved method for fabricating a nitrogenous steel material.

### SUMMARY

According to an aspect of the present disclosure, there is a method for fabricating a nitrogenous steel material. The method comprises preparing a material powder in a powder reservoir of an additive manufacturing apparatus. The material powder comprises: a metal powder comprising iron; and an alloying powder comprising nitrogen. The method further comprises performing an additive manufacturing process under atmospheric pressure, the additive manufacturing process comprising: displacing layers of the material powder from the powder reservoir to a build platform of the additive manufacturing apparatus; and fusing the layers of material powder on the build platform to fabricate the nitrogenous steel material.

A method for fabricating a nitrogenous steel material according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an apparatus for fabricating a nitrogenous steel material.

FIGS. 2A to 2C are illustrations of the morphology of chromium nitride powder.

FIGS. 3A and 3B are illustrations of samples of the nitrogenous steel material.

FIGS. 4A and 4B illustrate chemical compositions and processing parameters of material powders for fabricating the nitrogenous steel material samples.

FIGS. 5A and 5B illustrate chemical compositions and material properties of the nitrogenous steel material samples.

### DETAILED DESCRIPTION

For purposes of brevity and clarity, descriptions of embodiments of the present disclosure are directed to a method for fabricating a nitrogenous steel material, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment. As used herein, the terms “a” and “an” are defined as one or more than one. The use of “I” in a figure or associated text is understood to mean “and/or” unless otherwise indicated. The recitation of a particular numerical value or value range herein is understood to include or be a recitation of an approximate numerical value or value range.

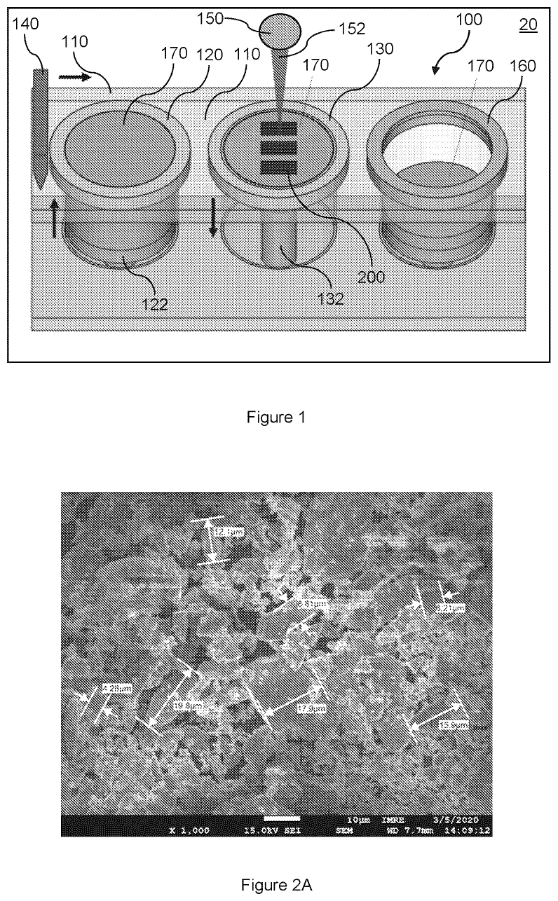

In representative or exemplary embodiments of the present disclosure, as shown in FIG. 1, there is an apparatus 100 for fabricating a nitrogenous steel material 200, i.e. a steel material that comprises nitrogen. The apparatus 100 is an additive manufacturing apparatus 100 configured for performing an additive manufacturing process, such as but not limited to selective laser melting or laser powder bed fusion. More specifically, the additive manufacturing process is performed under atmospheric pressure, which has a standard value of around 100 kPa.

The apparatus 100 is housed in a build chamber 20 that is enclosed and filled with an inert gas such as argon. The apparatus 100 includes a powder bed 110, a powder reservoir 120, a build platform 130, a displacer 140, a laser assembly 150, and an oversupply container 160. The powder reservoir 120 contains a material powder 170 for fabricating into the nitrogenous steel material 200 on the build platform 130. The displacer 140, also known as a recoater having a recoater blade or roller, is configured to displace the material powder 170 across the powder bed 110 from the powder reservoir 120 to the build platform 130. The laser assembly 150 is configured to laser the material powder on the build platform 130 to fabricate the nitrogenous steel material 200. The laser assembly 150 includes a laser source and optionally a set of optical elements to direct a laser beam 152 from the laser source towards the build platform 130. The oversupply container 160 is arranged to collect excess or waste material powder 170 displaced by the displacer 140 past the build platform 130.

In various embodiments, there is a method for fabricating the nitrogenous steel material 200 using the apparatus 100. The method includes an operation of preparing the material powder 170 in the powder reservoir 120 and an operation of performing the additive manufacturing process under atmospheric pressure.

The additive manufacturing process, such as selective laser melting, includes a step of displacing layers of the material powder 170 from the powder reservoir 120 to the build platform 130. The additive manufacturing process includes a step of fusing, using the laser assembly 150, the layers of material powder on the build platform 130 to fabricate the nitrogenous steel material 200.

During the additive manufacturing process, a powder displacement piston 122 moves upwards and pushes a layer of material powder 170 in the powder reservoir 120 upwards onto the powder bed 110, the layer having a predefined thickness. The displacer 140 then displaces the layer of material powder 170 across the powder bed 110 to the build platform 130. A build piston 132 moves the build platform 130 downwards in a reverse direction with respect to the powder displacement piston 122 pushing the layer of material powder 170. For example, the material powder 170 is pushed upwards by the layer's thickness by the powder displacement piston 122, and the build platform 130 is moved downwards by the same layer's thickness by the build piston 132 to accommodate the layer of material powder 170.

The laser assembly 150 emits and directs the laser beam 152 on the layer of material powder 170 at the build platform 130. The laser beam 152 scans the layer of material powder 170 according to a design file digitally representing the nitrogenous steel material 200. Upon scanning by the laser beam 152, the laser beam 152 melts and fuses the material powder 170, thereby forming a layer of the nitrogenous steel material 200.

After forming the layer of nitrogenous steel material 200, the powder reservoir 120 and powder displacement piston 122 supply the next layer of material powder 170 and the displacer 140 displaces it to the build platform 130. The build platform 130 is moved downwards by the build piston 132 to accommodate the next layer of material powder 170. The laser beam 152 scans the next layer of material powder 170 on the build platform 130 to form the next layer of the nitrogenous steel material 200. This is an iterative process that builds the nitrogenous steel material 200 layer by layer upwards on the build platform 130.

The design file, or computer aided design (CAD) file, is a configuration file that encodes one or more of the geometrical arrangement or shape of the graded metallic structure. The design file can take any now known or later developed file format. For example, the design file may be in the Stereolithography or “Standard Tessellation Language” (.stl) format, or the Additive Manufacturing File (.amf) format. Further examples of design file formats include AutoCAD (.dwg) files, Blender (.blend) files, Parasolid (.x_t) files, 3D Manufacturing Format (0.3mf) files, Autodesk (3ds) files, Collada (.dae) files and Wavefront (.obj) files, although many other file formats exist.

The material powder 170 in the powder reservoir 120 includes a metal powder comprising iron and an alloying powder comprising nitrogen. The metal powder may include a substantially pure iron material (i.e. pure iron powder) and/or one or more ferroalloy materials. The iron powder can be considered as pure if its purity is at least 99%. For example, the ferroalloy materials include ferromanganese (FeMn) and ferrochromium (FeCr). Exemplary metal powders such as iron powder, FeMn powder, and FeCr powder typically have spherical particles with particle sizes ranging from 15 to 50 microns.

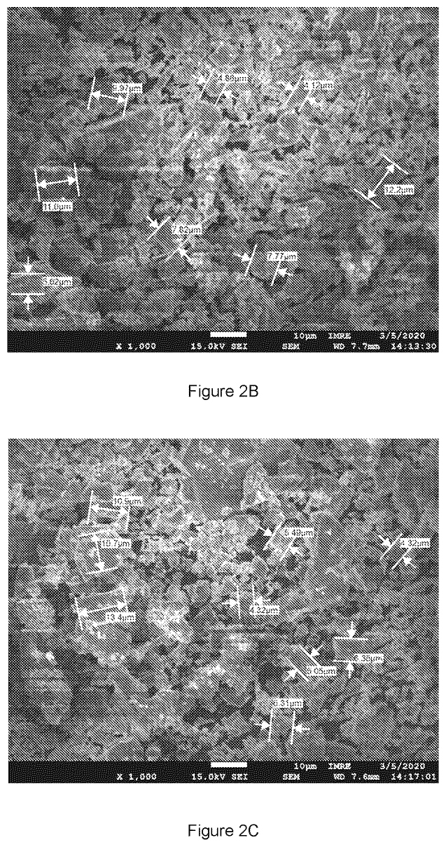

The alloying powder includes nitrogen and may be referred to as a nitrogenous alloying powder. For example, the alloying powder includes one or more of iron nitride (e.g. FeN/Fe₂N), chromium nitride (e.g. CrN/Cr₂N), ferrochrome nitride, manganese nitride, ferromanganese nitride, silicon nitride, and ferrosilicon nitride, etc. As shown in FIGS. 2A to 2C, the morphology of chromium nitride powder shows irregularly shaped particles with particle sizes ranging from 4 to 20 microns. Chromium nitride powder is more easily produced compared to directly mixing nitrogen into molten iron or steel which would require very high pressures.

In some embodiments, the material powder 170 further includes a second alloying powder for improving corrosion resistance of the nitrogenous steel material 200. The second alloying powder may include one or more of molybdenum and titanium.

The method for fabricating the nitrogenous steel material 200 may further include a step of mixing the metal powder with the alloying powder (and optionally with the second alloying powder) in a roller mill or ball mill to form the material powder. The method further includes a step of transferring the material powder from the roller mill to the powder reservoir 120. For example, the powders are mixed together in the roller mill at speeds of 150 rpm for a duration of 24 hours, wherein the roller-to-mass or ball-to-mass ratio is 1:1. Notably, the mixing of the powders is also performed under atmospheric pressure.

The nitrogenous steel material 200 fabricated by the apparatus 100 and additive manufacturing process has high nitrogen content due to the inclusion of the nitrogenous alloying powder in the material powder. The nitrogenous steel material 200 is considered as high nitrogen steel if it comprises at least 0.4% nitrogen by weight. However, excessive nitrogen content would deteriorate the toughness of the nitrogenous steel material 200. Preferably, the nitrogenous steel material 200 comprises 0.4% to 2.0% nitrogen by weight.

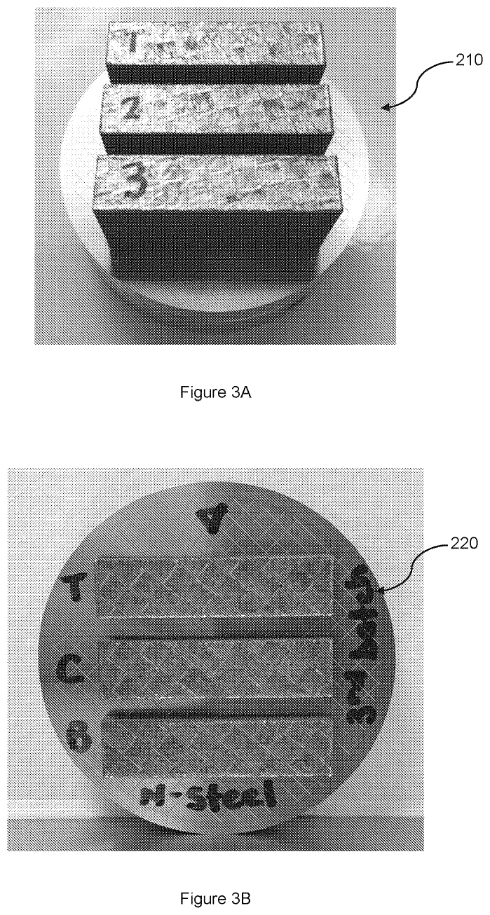

Products or samples comprising the nitrogenous steel material 200 were fabricated using the additive manufacturing process, specifically selective laser melting, performed under atmospheric pressure. FIGS. 3A and 3B show a first batch 210 and a second batch 220, respectively, of the fabricated samples of the nitrogenous steel material 200. The material powders 170 used to fabricate the first and second batches 210,220 of the nitrogenous steel material 200 includes a mixture of FeMn powder, FeCr powder, iron powder, and chromium nitride powder (e.g. CrN/Cr₂N) as the nitrogenous alloying powder. The chemical compositions (% by weight) of the material powders 170 for the first and second batches 210,220 are shown in FIG. 4A.

The first and second batches 210,220 of the nitrogenous steel material 200 are fabricated using selective laser melting under atmospheric pressure. The processing parameters used in the selective laser melting process is shown in FIG. 4B. The chemical compositions (by % weight) of the first and second batches 210,220 are shown in FIG. 5A. The chemical compositions show that the nitrogen content of the first and second batches 210,220 is about 0.56% and 0.87%, respectively, exceeding the atmospheric solubility limit of about 0.045%. Moreover, the nitrogenous steel material 200 is non-porous or has low porosity as evidenced by the good surface quality without any obvious pores on the surfaces of the first and second batches 210,220. The hardness of the nitrogenous steel material 200 was tested at various test points on the surfaces of the first and second batches 210,220. FIG. 5B shows that the material properties of the first and second batches 210,220, specifically the hardness properties. The hardness distribution is generally uniform at around number 300 for the first batch 210 and 360 for the second batch 220 on the Vickers HV0.5 scale.

Embodiments of the present disclosure describe a method for fabricating the nitrogenous steel material 200, the method including performing the additive manufacturing process (such as selective laser melting) under atmospheric pressure. The method combines the characteristic of rapid solidification of the additive manufacturing process with the alloy design of the material powder 170 which incorporates a higher percentage of nitrogen into the nitrogenous steel material 200. Further, the method is performed under standard atmospheric pressure. Production using the additive manufacturing process under standard atmospheric pressure is simpler, safer, and more reliable than the existing PIM and PESR processes which require very high pressures. As such high pressures are not needed, less energy is required to perform this method, thereby reducing production costs.

By controlling the processing parameters of the additive manufacturing process as well as the blend and quality of the material powder 170, the nitrogenous steel material 200 can be fabricated with uniform distribution and precise control of the nitrogen content. For example, optimizing the quality of the material powder 170 including its constituent iron-based metal powder and nitrogenous alloying powder can avoid incorporating harmful elements or impurities into the nitrogenous steel material 200.

The nitrogen in the nitrogenous steel material 200 functions as a replacement of nickel that is currently used to produce stainless steel. Like nickel, the nitrogen can stabilize the austenite phase of the nitrogenous steel material 200 at room temperature. Increasing the nitrogen content to beyond the atmospheric solubility limit enhances material properties such as hardness, strength, corrosion resistance, and wear resistance of the nitrogenous steel material 200.

The method can be used to fabricate nitrogenous steel material 200 with high nitrogen content and low to zero nickel content, including various types of intricate, complex shaped, and/or high value components. Some examples include medical components made of high nitrogen stainless steel because of high corrosion resistant properties, tooling components made of high nitrogen steel because of high strength and wear resistant properties, and high nitrogen structural steel because of high strength and toughness properties.

In the foregoing detailed description, embodiments of the present disclosure in relation to a method for fabricating a nitrogenous steel material 200 are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art.

Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. For example, although the additive manufacturing process performed to fabricate the nitrogenous steel material 200 is described as selective laser melting, it will be appreciated that other additive manufacturing processes instead of selective laser melting may be performed under atmospheric pressure, without departing from the scope of the present disclosure. Therefore, the scope of the disclosure as well as the scope of the following claims is not limited to embodiments described herein.

1. A method for fabricating a nitrogenous steel material, the method comprising:
preparing a material powder in a powder reservoir of an additive manufacturing apparatus, the material powder comprising:
a metal powder comprising iron; and
an alloying powder comprising nitrogen; and
performing an additive manufacturing process under atmospheric pressure, the additive manufacturing process comprising:
displacing layers of the material powder from the powder reservoir to a build platform of the additive manufacturing apparatus; and
fusing the layers of material powder on the build platform to fabricate the nitrogenous steel material.

2. The method according to claim 1, wherein the metal powder comprises a substantially pure iron material and/or one or more ferroalloy materials.

3. The method according to claim 2, wherein the ferroalloy materials comprise ferromanganese and ferrochromium.

4. The method according to claim 1, wherein the alloying powder comprises one or more of iron nitride, chromium nitride, ferrochrome nitride, manganese nitride, ferromanganese nitride, silicon nitride, and ferrosilicon nitride.

5. The method according to claim 1, wherein the material powder further comprises a second alloying powder for improving corrosion resistance of the nitrogenous steel material.

6. The method according to claim 5, wherein the second alloying powder comprises one or more of molybdenum and titanium.

7. The method according to claim 1, wherein the nitrogenous steel material comprises at least 0.4% nitrogen by weight.

8. The method according to claim 7, wherein the nitrogenous steel material comprises 0.4% to 2.0% nitrogen by weight.

9. The method according to claim 1, further comprising:
mixing the metal powder with the alloying powder in a roller mill to form the material powder; and
transferring the material powder from the ball mill to the powder reservoir.

10. The method according to claim 1, wherein the additive manufacturing process comprises selective laser melting.

11. A product comprising the nitrogenous steel material fabricated by the method according to claim 1.

12. The product according to claim 11, wherein the nitrogenous steel material comprises at least 0.4% nitrogen by weight.

13. The product according to claim 12, wherein the nitrogenous steel material comprises 0.4% to 2.0% nitrogen by weight.
